(19) United States
(12) Patent Application Publication
(10) Pub. No.: US 2022/0270173 A1
(43) Pub. Date: Aug. 25, 2022

(54) SYSTEM AND METHOD FOR AUTOMATICALLY OPTIMIZING A PORTFOLIO

(71) Applicant: THE TORONTO-DOMINION BANK, TORONTO (CA)

(72) Inventors: MATTHEW JAMES KNOX, TORONTO (CA); ANTON BRJOZOVSKI, TORONTO (CA); BO YAN, MISSISSAUGA (CA); SUJAY KATHROTIA, BRAMPTON (CA)

(21) Appl. No.: 17/185,277

(22) Filed: Feb. 25, 2021

(51) Int. Cl. G06Q 40/06; G06Q 10/04; G06N 20/00; G06F 9/451

(52) U.S. Cl. CPC G06Q 40/06; G06Q 10/04; G06N 20/00; G06F 9/451

(57) ABSTRACT

There is provided a computing device, systems and methods for automatic generation of a portfolio. The computing device receives an index comprising index holdings and characteristics. The device then automatically projects the index to a target index providing a proforma benchmark characterizing a future state of the index holdings. The target index is based on expected future events impacting the index and includes a list of projected constituents, characteristics defining each of the constituents. The computing device predicts, using a machine learning model, a liquidity score associated with each of the constituents, the liquidity score for a particular constituent based on prior liquidity scores for other constituents in a past time period with one or more similar characteristics to the characteristics of the particular constituent. In response, an optimized portfolio is generated providing an optimized set of constituents with associated weighting tracking the target index.

### FIELD

The present disclosure relates to a computerized system and method for automatically generating and optimizing a portfolio and more particularly to a system and method that automatically tracks and analyzes an index for deployment in generating the optimized portfolio.

### BACKGROUND

In passive fixed income management, there have been challenges in effectively rebalancing fixed income (FI) index funds. Traditionally, this has been done manually by different portfolio managers having access to different spreadsheets containing disparate information about an FI fund to be replicated and attempting to manually estimate how to best replicate the FI fund.

However, some items in the FI fund may have various characteristics that make them difficult to replicate directly. For example, poor liquidity (e.g. some bonds cannot be sold at all, or some bonds can be sold but unable to be found in the market again, or some bonds can be traded but the costs may be prohibitive) prevents direct replication of the funds. Additionally, criteria for replication of an FI index are more complex than other indices because of the large number of characteristics of the FI index that need to be matched for replication. For example, the criteria for “replication” of an FI index fund are more complex than an equity index. Notably, in addition to matching sector weights, there may be a need to match many more characteristics of the index.

The above issues make the portfolio optimization problem impossible to be performed manually and any such manual estimation of a passive fixed income portfolio would lead to vast inaccuracies and errors. Additionally, delays of presenting information to a user regarding the portfolio render such manual systems useless.

Furthermore, defining a portfolio manually can be both time consuming and error prone. It is vital to define a portfolio with correct content that efficiently tracks an index such as a fixed income index.

Accordingly, there exists a need to obviate or mitigate at least some of the above-mentioned disadvantages of existing systems and methods. Notably, there is a need to dynamically define a portfolio with correct content that efficiently tracks an index such as a fixed income index. The proposed system and method provide an automatic optimization tool for generating and optimizing a portfolio for indexes such as those used in passive fixed income management.

### SUMMARY

It is to be understood that both the foregoing general description and the following detailed description are exemplary and explanatory only and are not restrictive of the claims.

In one aspect, there is provided an improved system and method for automating real-time portfolio optimization suitable for passive fixed income funds, such as bonds, where the liquidity may be a concern and the index is not directly replicable.

In one aspect, there is provided a system and method which generates an optimized portfolio for tracking a passive index, e.g. a fixed income index and exposes the optimized portfolio information (e.g. its constituents and characteristics) on a real-time integrated dashboard user interface for subsequent interaction and manipulation of the portfolio. Additionally, in yet another aspect, the optimized portfolio is generated with additional constraints such as a limited number of constituents (e.g. securities), while maintaining a desirable representativeness of the FI fund. In yet another aspect, the system and method generates an optimized portfolio which represents the sector weights of the index fund but additionally considers characteristics of the fund such as overall duration, sector duration, rating weights, etc. In at least some aspects, the optimized portfolio selects a limited subset of the list of projected constituents from the target index having optimal liquidity scores and the associated weighting similar to the weighting in the target index.

In yet another aspect there is provided an automated real-time portfolio optimization suitable for passive fixed income funds.

Advantageously, in at least some implementations, the disclosed system and method improves efficiency, and accuracy of concurrently managing and optimizing a number of portfolios (e.g. fixed income portfolios), in real-time, by minimizing tracking error to a desired index (e.g. passive fixed income index) while considering preferences for the portfolios when optimizing the portfolios. In at least some aspect, there is provided a portfolio analyzer for analyzing the desired index including forecasting the index into a future state (proforma benchmark or target index) and predicting liquidity levels of the index's holdings.

Further advantageously, in at least some aspects, the disclosed systems and methods provide at least one user interface, which presents analytics information (e.g. liquidity levels, proforma benchmarks, optimized portfolios, etc.) on a visual display for subsequent manipulation by a user such that any such manipulation results in all users of the user interface receiving updated real-time analytics information on their corresponding local displays. Thus, this allows users (e.g. portfolio managers) to collaborate and share the application data related to the portfolio analytics and output portfolio in a shared worker environment such as to automatically compute any changes resulting from a particular user's actions to all related users associated with the portfolio.

In at least some implementations, there is provided a computing device for automatic generation of a portfolio, the computing device comprising a processor, a storage device and a communication device where each of the storage device and the communication device is coupled to the processor, the storage device storing instructions which when executed by the processor, configure the computing device to: receive an index comprising index holdings and characteristics; automatically project the index from a current time period to a future time period as a target index providing a proforma benchmark characterizing a future state of the index holdings, the target index projected based on expected future events impacting the index, the target index comprising: a list of projected constituents, characteristics defining each of the constituents and a weighting of each of the constituents within the target index; automatically predict, using a machine learning model, a liquidity score associated with each of the constituents, the liquidity score for a particular constituent based on prior liquidity scores for other constituents in a past time period with one or more similar characteristics to the characteristics of the particular constituent; and, in response to the target index and the liquidity score, generate, in real-time an optimized portfolio providing an optimized set of constituents with associated weighting tracking the target index.

In at least some implementations, there is provided a computer-implemented method for automatic generation of a portfolio, the method performed on a computer device, the method comprising: receiving an index comprising index holdings and characteristics; automatically projecting the index from a current time period to a future time period as a target index providing a proforma benchmark characterizing a future state of the index holdings, the target index projected based on expected future events impacting the index, the target index comprising: a list of projected constituents, characteristics defining each of the constituents and a weighting of each of the constituents within the target index; automatically predicting, using a machine learning model, a liquidity score associated with each of the constituents, the liquidity score for a particular constituent based on prior liquidity scores for other constituents in a past time period with one or more similar characteristics to the characteristics of the particular constituent; and in response to the target index and the liquidity score considered along with a set of pre-defined constraints for desired portfolio characteristics, generating, in real-time on a user interface (UI) of the device, an optimized portfolio providing an optimized set of constituents with associated weighting tracking the target index.

It is to be understood that both the foregoing description and the following detailed description are exemplary and explanatory only and are not restrictive of the disclosure. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

These and other features of the disclosure will become more apparent from the following description in which reference is made to the appended drawings wherein:

FIG. 1 is a block diagram illustrating an example computing device communicating in a communication network and configured to output for display a recommended optimized portfolio (e.g. a bond portfolio) generated from an index being tracked (e.g. a passive fixed income index fund), in accordance with one or more aspects of the present disclosure.

FIG. 2 is a block diagram illustrating the computing device of FIG. 1, in accordance with one or more aspects of the present disclosure.

FIG. 3 is a block diagram illustrating more detail of FIG. 2, including an embodiment of a liquidity module, in accordance with one or more aspects of the present disclosure.

FIG. 4 is a flowchart illustrating example operations of a computing device (e.g. the computing device of FIG. 1), in accordance with one or more aspects of the present disclosure.

FIGS. 5-6 are diagrams illustrating example graphical user interfaces or portions thereof, in accordance with one or more aspects of the present disclosure.

### DETAILED DESCRIPTION

While various embodiments of the disclosure are described below, the disclosure is not limited to these embodiments, and variations of these embodiments may well fall within the scope of the disclosure. Reference will now be made in detail to embodiments of the present disclosure, examples of which are illustrated in the accompanying drawings. Wherever possible, the same reference numbers will be used throughout the drawings to refer to the same or like parts.

Generally, in at least some embodiments, there is provided a computer-implemented automated real-time portfolio optimization system and method suitable for passive fixed income (FI) funds. Thus, in at least some embodiments, an accurate and efficient portfolio having constituents and weighting tracking an index (e.g. an FI index fund) is generated on a user interface by utilizing: (a) a proforma benchmark index of a future state of the index to track and optimize against and (b) automatically predicted liquidity levels for each holding in the benchmark index forecasted based on machine learning prediction models to characterize an index constituent item (e.g. a holding) to a historical one having similar characteristics.

Thus, in at least some aspects, the portfolio generated by the disclosed systems and methods aims to minimize tracking error to the proforma benchmark index (e.g. minimize constraints on characteristics of the index) while applying a penalty related to the predicted liquidity levels. In at least one aspect, a predictive machine learning model (e.g. random forest or neural network) is used to assign liquidity levels by classifying individual items such as bonds within the tracked portfolio as similar to others based on tracking characteristics. Generally, there is also provided a user interface which allows defining portfolio characteristics of the optimized portfolio to update, in real-time, the optimized portfolio. In at least some aspects, a user interface additionally allows defining the desired characteristics of the portfolio (e.g. limiting the number of holdings, or defining sector preferences).

The proposed system and method is further advantageous as in at least one aspect, it reduces errors in tracking the index via generating the proforma benchmark. Additionally, in at least one aspect, the proposed system and method reduces wasting computer resources as it provides a plurality of computer components (e.g. index analytics module, liquidity predictor module, proforma benchmark generator, portfolio optimizer) which co-operate in real-time to generate an optimized portfolio while minimizing constraints on the index characteristics and applying a penalty to the predicted liquidity levels. This further improves the efficiency and accuracy of the portfolio (e.g. bond portfolio tracking the fixed income index fund) generated by the disclosed methods and system.

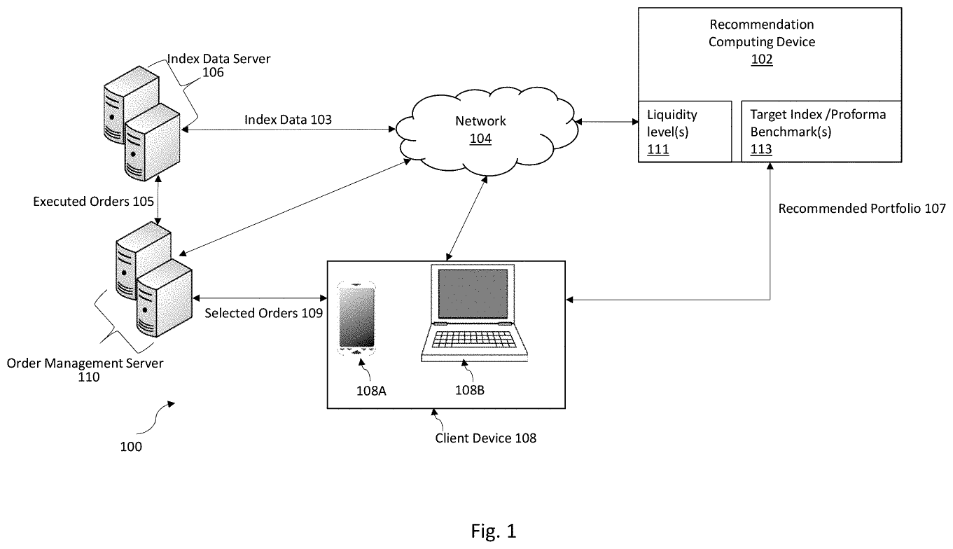

FIG. 1 is a diagram illustrating an example computer network 100 in which a recommendation computing device 102 is configured to communicate, using a communication network 104, with one or more other computing devices, including an index data server 106, one or more client device(s) 108 and an order management server 110. In FIG. 1, client device(s) 108 may be different types of computing devices such as a handheld mobile computing device 108A and a mobile computer 108B (collectively shown as 108). Recommendation computing device 102 may be configured to receive, from an index data server 106 (also may be referred to as a data hub), index data 103 characterizing the index to be tracked. The index data 103 may comprise index holdings and characteristics. For example, the index data 103 may include but not be limited to: prices (e.g. price for each current holding and/or expected trade), positions (e.g. current positions), index holdings (e.g. target benchmark), trades executed and/or to be settled, client purchases and redemptions (CPR) and other characteristics defining the index (e.g. passive fixed income fund).

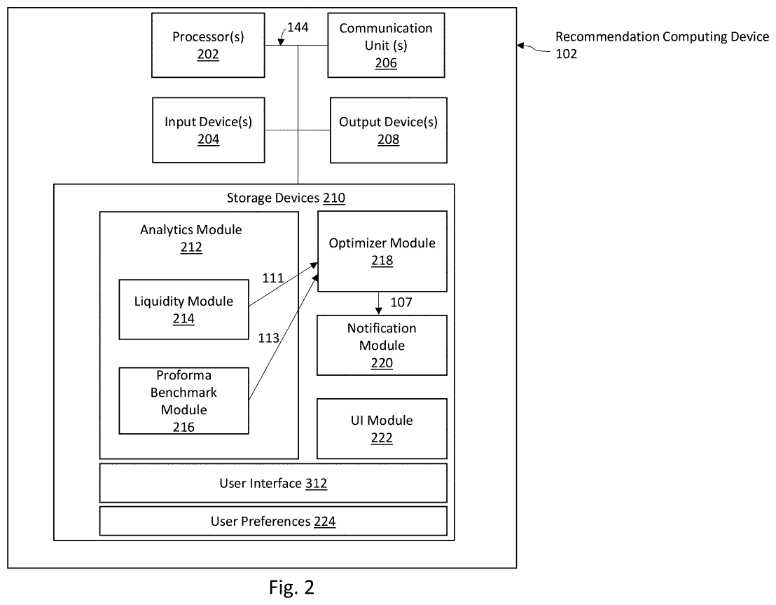

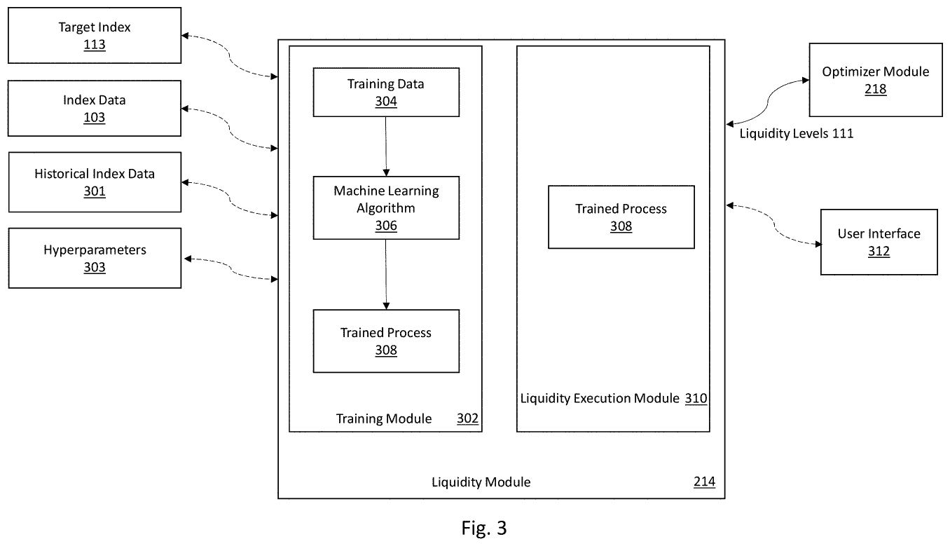

Thus, information about a specific index being tracked is retrieved via the index data 103. Based on this, the recommendation computing device 102 is configured to generate a recommended portfolio 107 which is dynamically optimized. As will be described further with reference to FIGS. 2 and 3, such recommendations are based on the recommendation computing device 102 analyzing the index data 103 and generating (1) predicted liquidity levels 111 for each of the index holdings and (2) target index 113. The target index 113 (also referred to as a proforma benchmark herein) is a forecasted future state of the index holdings from the index data 103 based on known/predicted future events affecting the index.

Referring to the target index 113 (also referred to as the proforma benchmark), the recommendation computing device 102 automatically projects or forecasts the index (as retrieved from index data 103) from a current time to a future time based on predictable events resulting in index changes. As will be described, advantageously, the recommendation computing device 102 generates a recommended portfolio 107 which closely tracks and optimizes against the target index 113 by having a tracking error as close to zero as possible given other constraints (e.g. user preferences or limitations on number of held in the portfolio).

Referring to FIGS. 1 and 3, the recommendation computing device 102 further automatically generates predicted liquidity levels 111 from the index data 103 using a machine learning predictive model (e.g. random forest or neural network). Notably, the recommendation computing device 102 (via the liquidity module 214 shown in FIG. 2) assigns a particular liquidity level 111 for each of the target index constituents in the target index 113 based on characteristics of the particular constituent (e.g. sector, coupon, time to maturity) and/or historical data.

As will be described in further detail below, the recommendation computing device 102 is configured to utilize the predicted liquidity levels 111 and the target index 113 to generate a set of recommended portfolio(s) 107 (e.g. via an optimizer module 218 depicted in FIG. 2) having a set of constituents and respective characteristics (e.g. weighting tracking that of the index data 103).

Referring again to FIG. 1, once the recommendation computing device 102 generates the recommended portfolio 107, this may be provided to one or more client device 108. The recommended portfolio 107 may for example be displayed on a browser associated with the client device 108 by accessing a website/software program associated with the recommendation computing device 102. Alternatively, the recommended portfolio 107 may be provided to the client device 108 for local display thereon. Upon receiving the recommended portfolio 107 (including an optimized set of constituents and corresponding weighting), the client device 108 may receive input on a user interface thereon modifying the recommended portfolio 107 and provide said feedback to the recommendation computing device 102 for subsequent analysis.

Furthermore, the client device 108 may receive user input selecting orders based on the recommended portfolio 107. Selected orders 109 (e.g. trades requested for purchasing/selling) are then submitted from the client device 108 to the order management server 110 which then executes the selected orders 109 (e.g. on a central repository containing all of the trades for all client devices 108). For example, the order management server 110 is configured to allow an authorized user (e.g. of a client device 108) to place and execute orders for trades of various types of securities (e.g. stocks, bonds, futures, options, derivatives etc.) in real time.

Once the orders execute, the order management server 110 provides the executed orders 105 to the index data server 103. The index data server 103 contains a data hub repository for storing and managing the state of each account for users of client devices 108 such as, for example, the prices, positions, balances, rules for each account, index holdings, trade status, etc.

In the example of FIG. 1, the recommendation computing device 102 is a distributed computing server communicating on the network 104. Other examples of the recommendation computing device 102 is a single computer, cloud computing services, a laptop computer, a tabletop computer, or another type of computing device. In the example of FIG. 1, client device 108 may be a cell phone, a laptop, an intermediary third party, etc., each may have different storage capacity, processing power, user interfaces (e.g. native application, browser, etc.), communication capabilities and communication connections with different qualities when communicating queries (e.g. for requesting an optimized portfolio or modifications to the portfolio) and receiving responses from recommendation computing device 102.

In the example of FIG. 1, the order management server 110 and the index data server 106 are distributed servers but they may be any computing devices that have at least one processing device (e.g. a processor) and memory (e.g. a storage device), storing instructions which when executed by the processing device configure the computing devices for performing the operation(s) described herein, including for example: receiving requests for trade orders; providing responses related to the orders; modifying any one of liquidity levels 111, target index 113 and portfolio 107.

Recommendation computing device 102 is coupled for communication to network 104 which may be a wide area network (WAN) such as the Internet. Network 104 is coupled for communication with index data server 106, client device 108, and order management server 110. It is understood that network 104 is simplified for illustrative purposes. Additional networks may also be coupled to the WAN of network 104 such as a wireless network and/or a local area network (LAN) between the WAN and recommendation computing device 102 or between the WAN and any of devices shown in FIG. 1.

FIG. 2 is a diagram illustrating in block schematic form, an example computing device (e.g. the recommendation computing device 102 shown in FIG. 1), in accordance with one or more aspects of the present disclosure, for example to provide a system and method to dynamically generate an optimized trade portfolio. Preferably, the optimized trade portfolio generated minimizes a constraint defined by the characteristics of the target index tracked and a penalty applied for the predicted liquidity levels of the target index.

Recommendation computing device 102 comprises one or more processors 202, one or more input devices 204, one or more communication units 206 and one or more output devices 208. Recommendation computing device 102 also includes one or more storage devices 210 storing one or more modules such as analytics module 212 further comprising a liquidity module 214 and a proforma benchmark module 216, an optimizer module 218, a notification module 220 and a UI module 222. Communication channels 144 may couple each of the components including processor(s) 202, input device(s) 204, communication unit(s) 206, output device(s) 208, storage device(s) 210, analytics module 212, liquidity module 214, proforma benchmark module 216, optimizer module 218, notification module 220, UI module 222 for inter-component communications, whether communicatively, physically and/or operatively. In some examples, communication channels 144 may include a system bus, a network connection, an inter-process communication data structure, or any other method for communicating data.

One or more processors 202 may implement functionality and/or execute instructions within recommendation computing device 102. For example, processors 202 may be configured to receive instructions and/or data from storage devices 210 to execute the functionality of the modules shown in FIG. 2, among others (e.g. operating system, applications, etc.). Recommendation computing device 102 may store data/information to storage devices 210. Some of the functionality is described further herein below.

One or more communication units 206 may communicate with external devices (e.g. index data server 106, client devices 108, and order management server 110) via one or more networks (e.g. communication network 104) by transmitting and/or receiving network signals on the one or more networks. The communication units 206 may include various antennae and/or network interface cards, etc. for wireless and/or wired communications.

Input devices 204 and output devices 208 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 220).

The one or more storage devices 210 may store instructions and/or data for processing during operation of recommendation computing device 102. The one or more storage devices 210 may take different forms and/or configurations, for example, as short-term memory or long-term memory. Storage devices 210 may be configured for short-term storage of information as volatile memory, which does not retain stored contents when power is removed. Volatile memory examples include random access memory (RAM), dynamic random access memory (DRAM), static random access memory (SRAM), etc. Storage devices 210, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Analytics module 212 may be configured to obtain input from index data server 106 providing index data 103 which may include: index holdings and characteristics of a particular index of interest (e.g. duration, rating, prices, weighting, sectors, etc.), and user account historical trading information such as trades, prices, positions, etc.

The input data may instruct the performance by the proforma benchmark module 216 of automatically projecting the index into a future state (e.g. a future time period) to define a target index (also referred to as a proforma benchmark) based on expected events affecting the index. Such events affecting the index may include for example, coupon payments, re-openings and new issues, index extensions and roll-outs with various amortization periods which may affect the index holdings and/or characteristics. Since the index to be replicated (or closely tracked) as provided by the index data 103 is dynamically and constantly changing based on events affecting its component individual indices, the liquidity module 214 aims to pre-position the portfolio to the forecasted changes, in order to reduce the tracking error. Thus, the generated target index 113 (providing a proforma benchmark) is computed automatically to account for the various changes expected.

For example, in order to generate the target index 113, the proforma benchmark module 216 may retrieve and access a storage of expected events (e.g. stored on storage device 210) that are relevant to each of the index holdings in the index data 103. The proforma benchmark module 216 may then apply the expected events (e.g. planned to occur between a current time and a pre-defined future time for when the portfolio recommendations 107 are being generated) to each of the relevant indices in the index data 103 to project the impact on the index data 103. Notably, the proforma benchmark module 216 projects predictable index changes onto the index data 103 and generates the target index 113 as proforma benchmarks. The target index 113 may include for example a passive fixed income index. The target index 113 comprises: a projected list of index constituents (e.g. bonds), their characteristics (e.g. sector, coupon, time to maturity, duration, rating, and price) and the relevant weighting within the index. In at least some examples, the pre-defined future time may be pre-defined based on historical data and/or user-defined via the computing systems described herein.

In one example, the proforma benchmark module 216 displays the target index 113 on a user interface 312 of the recommendation computing device 102 (or alternatively accessible via devices 108) using the UI module 222 to illustrate how the index will appear at a given future time and/or allow modifications to the target index 113.

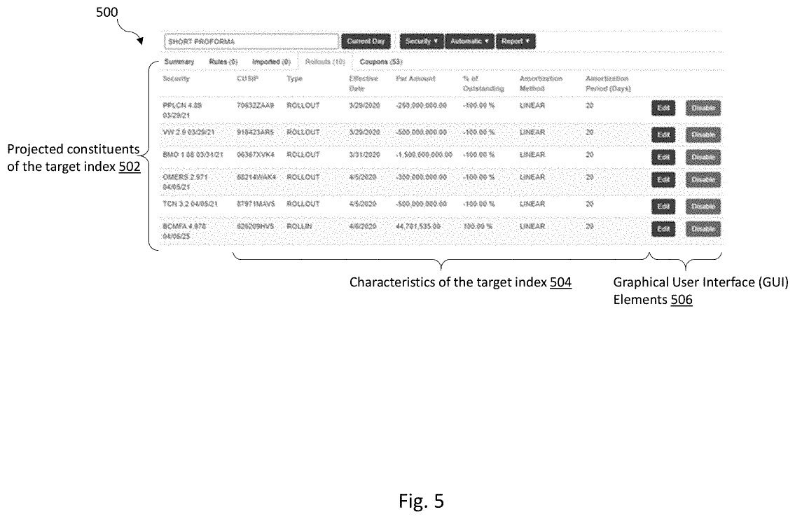

In at least one aspect, as shown in FIG. 5, UI module 222 may present a graphical view 500 of the target index 113 including the projected constituents of the target index 502 and the corresponding characteristics of the target index 504. The graphical view 500 and other such graphical views depicting the target index 113, index data 103 or the recommended portfolio 107 may be presented via a user interface of the recommendation computing device 102 using the UI module 222 depicted in FIG. 2. The characteristics of the target index 504 may include but not limited to: a security descriptor, a unique identifier, a transaction type, an effective date, a par amount such as face value of bond, % of outstanding, an amortization method, and amortization period (days). Additionally, as shown in the view 500, a plurality of graphical user interface (GUI) elements 506 may also be presented on the user interface view 500 associated with the recommendation computing device 102 for manipulating the target index including, the projected constituents of the target index 502 and/or characteristics of the target index 504. Any modifications or input received via the GUI elements 506 to update the target index items or their characteristics may be used to update user preferences (e.g. see user preferences 224 in FIG. 2) so that subsequent iterations of forecasting the target index (e.g. via a proforma benchmark module 216) take into account the user preferences 224 (e.g. previously defined or defined via the UI module 222). Additionally, in at least one aspect, in response to receiving an override request to the projection of the index from a present state to the future state as the target index (e.g. via the GUI elements 506), the UI module 222 may be configured to communicate with the notification module 220 to generate an electronic report (e.g. email notification) to at least one user associated with receiving the optimized portfolio 107.

Referring again to FIG. 2, upon receipt of the index data 103, the proforma benchmark module 216 is configured to automatically predict, using a machine learning model, a liquidity level 111 (also referred to as a liquidity score) for each of the constituents of the target index 113. In at least one aspect, the liquidity level 111 for a particular constituent is based on historical liquidity scores for other constituents in a past time period having one or more similar characteristics to the characteristics of the particular constituent.

Referring to FIG. 3, shown is an embodiment of the liquidity module 214 of FIG. 2. In one aspect of the liquidity module 214, a liquidity level 111 for an index constituent (e.g. a particular security holding in the target index) may be calculated by classifying the index constituent as similar to other index constituent(s) based on its characteristics (e.g. a bond having a duration, a rating, and/or a price as a bond with a historical liquidity value attributed thereto) and thereby apply a same liquidity level 111. The liquidity module 214 may determine similarity based on analyzing that there is a degree of overlap between one or more characteristics between the index constituents.

Predicting liquidity levels is one of the biggest challenges in fixed income portfolios and is typically manually estimated which can lead to significant errors, as it is impossible to characterize a large number of similar characteristics. In at least some aspects, the present system and method streamlines the process to accurately determine the liquidity levels 111 in real-time by applying machine learning models as described herein.

Liquidity module 214 performs two operations: training via training module 302 and execution via liquidity execution module 310.

Training module 302 generates a trained process 308 for use by the liquidity execution module 310 to predict liquidity levels 111. Training module 302 comprises training data 304 and machine learning algorithm 306. Training data 304 is a database of historical index data 301 (index holdings, index constituent characteristics including overall duration and sector duration, rating, price, sector weights, sector, coupon, time to maturity, etc.) and respective liquidity levels 111 for individual index items (e.g. bonds) in the historical index data 301. Machine learning algorithm 306 may be a regression or a classification method and attempts to find an optimal trained process 308. The trained process 308 automatically maps each index item in the historical index data 301 to a set of processes that would generate an optimal measure of liquidity. This training may include executing, by the training module 302, a machine learning algorithm 306 to determine a set of model parameters based on the training set, including historical index data 301.

In one aspect, the machine learning algorithm 306 is a regression method using one or more of linear regression, logistic regression, and polynomial regression. In another aspect, the machine learning algorithm 306 is a supervised classification using one or more of neural network, support vector machine, linear or quadratic discriminate analysis, and boosting. In another aspect, the machine learning algorithm 306 is an unsupervised classification using one or more of k-means (clustering), Gaussian mixture models, and principal or independent component analysis.

Additionally or alternatively, the machine learning algorithm 306 may include a decision tree algorithm, which may include a tree ensemble algorithm (e.g., generated using bagging and/or boosting), a random forest algorithm, or a boosted trees algorithm.

Liquidity execution module 310 uses the trained process 308 to find an optimal relationship between the target index 113 constituents (e.g. bonds) and associated predicted liquidity levels 111. In one aspect, the machine learning model thus predicts the liquidity level 111 for a particular index item in the target index 113 based on determining that there is a degree of overlap of similar characteristics (e.g. sector, coupon, time to maturity, etc.) between the particular index item and one or more other index items defined in the historical index data 301.

The liquidity module 214 may use one or more hyperparameters 303 to tune the machine learning model generated in the trained process 308. A hyperparameter may include a structural parameter that controls execution of the machine learning algorithm 306, such as a constraint applied to the machine learning algorithm 306. Unlike a model parameter, a hyperparameter 303 is not learned from data input into the model. Example hyperparameters 303 for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm. Preferably, the hyperparameters 303 define that the decision tree algorithm applied by the machine learning algorithm 306 is a random forest algorithm. In one aspect, the hyperparameters 303 may be defined via user interface 312 or previously defined.

In one embodiment, the liquidity levels 111 generated may also be presented on user interface 312 of recommendation computing device 102, to allow user input to override liquidity score for a particular constituent of the target index 113. Additionally or alternatively, the user interface 312 may receive input to override index constituent classifications performed by the machine learning algorithm 306 (e.g. override whether two index constituents are similar) thereby causing an automatic retraining of the machine learning algorithm 306 based on the manual override input.

In some implementations, machine learning algorithm's fit metrics are calculated such as cross validation score and other such error metrics. Notably, the liquidity module 214 may perform cross-validation when training machine learning algorithm 306. Cross validation can be used to obtain a reliable estimate of machine learning model performance by testing a machine learning algorithm 306 ability to predict new data that was not used in estimating it. The liquidity module 214 may combine the cross-validation scores for each training procedure to generate an overall cross-validation score for the machine learning model used by the machine learning algorithm 306. The overall cross-validation score may include, for example, an average cross-validation score (e.g. across all training procedures), a standard deviation across cross-validation scores, or a standard error across cross-validation scores. In some aspects, the liquidity module 214 may compare the performance scores for each machine learning model implemented by the machine learning algorithm (e.g. where a plurality of different machine learning models have been used), and may select the machine learning model with the best (e.g., highest accuracy, lowest error, or closest to a desired threshold) performance score as the trained process 308.

Referring again to FIGS. 2 and 3, optimizer module 218 receives liquidity levels 111 (as generated via liquidity module 214) and target index 113 (e.g. proforma benchmarks generated via proforma benchmark module 216) and performs optimization to generate optimized portfolio 107. The optimizer module 218 determines, in real-time, an optimized portfolio 107 comprising a set of optimized index constituents, characteristics for each constituent and weighting. In at least some implementations, this process advantageously minimizes tracking error to the target index 113 by having a constraint defined by the characteristics and a penalty applied related to the liquidity levels 111.

In at least some implementations, the optimized portfolio 107 generated may be further customized via user preferences 224 input on user interface 312. User preferences 224 may include desired portfolio characteristics (e.g. a set of pre-defined constraints for generating the portfolio 107). Upon receipt of the pre-defined constraints input on user interface 312 associated with a particular account or user profile, the optimizer module 218 further updates the optimized portfolio 107 to account for the pre-defined constraints.

In at least some implementations, the optimizer module 218 runs using a distributed computing cluster such as to enable real-time generation of multiple optimized portfolios for a plurality of different users/accounts.

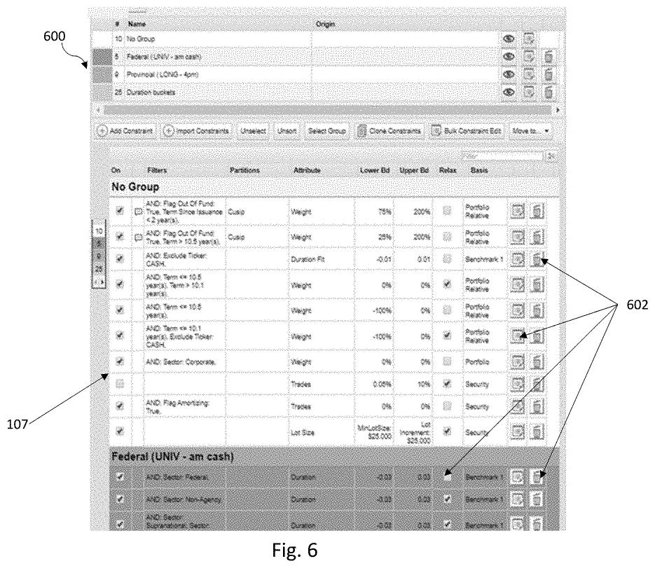

Referring to FIGS. 2 and 6, the optimized portfolio 107 may be displayed on the user interface 312 and/or other user interfaces associated with client devices 108 via the UI module 222. The user interface 312 allows users (e.g. portfolio managers) to review the trades in real-time and make adjustments where needed. In one implementation, the UI module 222 may receive input to modify the set of constituents provided as recommendations in the form of the optimized portfolio 107. Advantageously, this allows users (e.g. the portfolio managers) to interactively tweak the optimized portfolio 107 in real-time. Suggested changes may be propagated to other user devices related to the portfolio (e.g. other client devices 108) for additional approval (e.g. a PM manager). Once approved, in response to the input to modify the recommended optimized portfolio 107 (e.g. to remove a constituent, add a constituent, or modify characteristics of a constituent suggested) the optimizer module 218 may log user preferences 224 (e.g. via UI module 222). These modifications may subsequently be used modify the operations of the liquidity module 214, proforma benchmark module 216 and/or optimizer module 218 to update subsequent recommendations generated based on corresponding characteristics for the modified optimized set of constituents (e.g. the modified optimized portfolio).

FIG. 6 shows a view 600 of a graphical user interface (GUI) provided by the UI module 222 displaying the optimized portfolio 107 (e.g. as generated via the optimizer module 218) including a plurality of interactive GUI elements 602 allowing modification of the projected index constituents and/or characteristics. In at least some implementations, the GUI may receive input via GUI elements 602 for modifying underlying values used by the liquidity module 214, proforma benchmark module 216 and/or optimizer module 218. For example, the request to modify a portfolio profile of the optimized portfolio 107 displayed (e.g. request for modifying the constraint function used by the optimizer module 218 by modifying the portfolio characteristics or the penalty function for the portfolio) to trigger generating an updated optimized portfolio based on the request for modification.

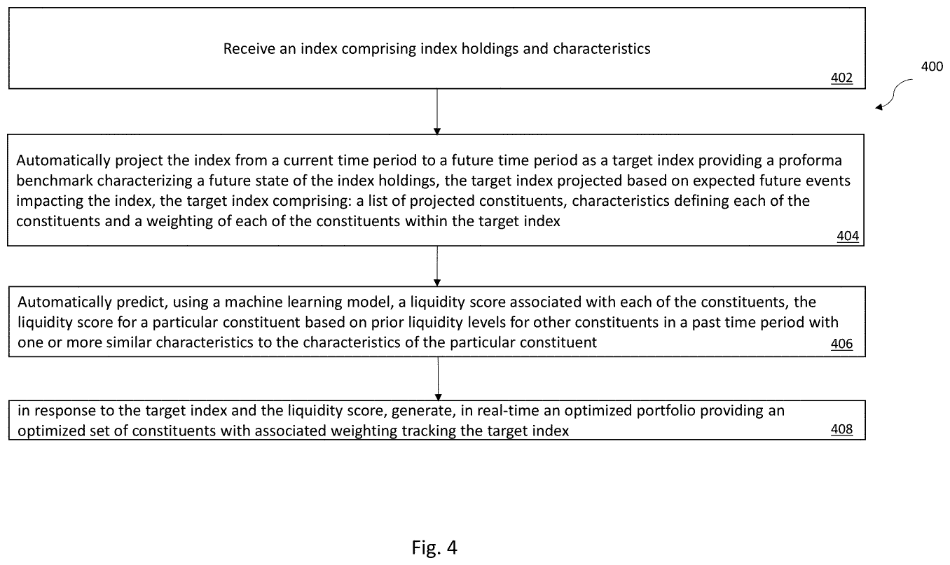

FIG. 4 is a flowchart illustrating example operations 400 which may be performed by a computing device, such as the recommendation computing device 102 illustrated in FIG. 1, in accordance with at least one aspect of the present disclosure.

Operations 400 receive index information (e.g. for a passive fixed income index) to be replicated for generating an optimized portfolio which tracks the index information as described with reference to FIG. 1. Additionally, the operations project predictable index changes to generate proforma benchmarks, predict liquidity levels of index items including securities and new issues and thereby generate the optimized portfolio. Additionally, operations 400 train a machine learning model using historical liquidity levels for known index holdings to determine current liquidity levels for index items forecasted to a future time as needed by the optimized portfolio.

At 402, operations of the computing device receive an index (e.g. a passive fixed income index) comprising index holdings (e.g. bonds) and index characteristics (e.g. sector weights, overall duration, sector duration, rating weights, etc.). Additionally, in at least some aspects, operations of the recommendation computing device 102 may retrieve from an associated storage, pre-defined desired portfolio characteristics, which define a profile for the portfolio (e.g. preferred types of index items, number of securities, preferred sector weights, etc.).

At 404, operations automatically project the index from a current time period to a future time period as a target index (also referred to as a proforma benchmark). The projected target index characterizes a future state of the index holdings (and corresponding characteristics) based on expected events affecting the index until the future time period. The expected events can include for example, index extensions and roll-outs, coupon payments affecting indices, re-opening and new issues affecting indices, and/or manual input of additional events or override of expected events provided via a user interface of the computing device. Based on the projected impact of the expected events, operations 404 define the target index comprising: a list of projected constituents (e.g. bonds), characteristics defining each of the constituents (e.g. characteristics taking into account the expected upcoming events) and a weighting of each of the constituents within the target index. The weighting may be defined for example based on the original index sector weighting for each individual index item and/or expected impact of future events on the weighting and/or pre-defined portfolio characteristics defined for a particular portfolio.

At 406, operations automatically predict, using a machine learning model, a liquidity score associated with each of the projected constituents of the target index. The liquidity score for a particular constituent (e.g. projected bond) based on prior historical liquidity levels for other constituents in a past time period with one or more similar characteristics to the characteristics of the particular constituent. Thus, for example, the operations may allow ranking a particular forecasted index item (e.g. a bond) liquidity based on its characteristics, such as sector, coupon, time to maturity, etc. Also, in some implementations, the machine learning model's fit metrics are further computed such as the cross validation score and other error metrics for selecting and validating the machine learning model. In some aspects of operation 406, a user interface of the recommendation computing device 102 may generate a diagnostic report which displays the liquidity score as well as predictions made by the recommendation computing device 102 for generating the liquidity score such as to allow overrides for incorrect predictions and retraining the machine learning model therefrom.

At 408, operations of the recommendation computing device 102, generate, in real-time, an optimized portfolio based on the target index and the liquidity score for the target index. The optimized portfolio provides an optimized set of constituents (e.g. based on constituents from the target index, further refined by limitations on the number of constituents and liquidity levels predicted such as to optimize liquidity values overall). Additionally, the associated weighting in the optimized set of constituents closely tracks the representation in the target index.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using wired or wireless technologies, such are included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. Also, the techniques could be fully implemented in one or more circuits or logic elements. The techniques of this disclosure may be implemented in a wide variety of devices or apparatuses, an integrated circuit (IC) or a set of ICs (e.g., a chip set).

One or more currently preferred embodiments have been described by way of example. It will be apparent to persons skilled in the art that a number of variations and modifications can be made without departing from the scope of the disclosure as defined in the claims.

What is claimed is:

1. A computing device for automatic generation of a portfolio, the computing device comprising a processor, a storage device and a communication device where each of the storage device and the communication device is coupled to the processor, the storage device storing instructions which when executed by the processor, configure the computing device to:
receive an index comprising index holdings and characteristics;
automatically project the index from a current time period to a future time period as a target index providing a proforma benchmark characterizing a future state of the index holdings, the target index projected based on expected future events impacting the index, the target index comprising: a list of projected constituents, characteristics defining each of the constituents and a weighting of each of the constituents within the target index;
automatically predict, using a machine learning model, a liquidity score associated with each of the constituents, the liquidity score for a particular constituent based on prior liquidity scores for other constituents in a past time period with one or more similar characteristics to the characteristics of the particular constituent; and
in response to the target index and the liquidity score, generate, in real-time an optimized portfolio providing an optimized set of constituents with associated weighting tracking the target index.

2. The computing device of claim 1, further comprising the processor configuring the computing device to: present a user interface (UI) to receive a set of pre-defined constraints for desired portfolio characteristics; and updating the optimized portfolio further in response to the pre-defined constraints.

3. The computing device of claim 2, wherein the optimized portfolio minimizes tracking error to the target index by having a constraint function related to the characteristics for each of the constituents and a penalty function related to the liquidity score of each of the constituents.

4. The computing device of claim 3, wherein the UI is further configured to receive input for modifying a portfolio profile of the optimized portfolio comprising at least one modifying of the constraint function via modification of the desired portfolio characteristics and the penalty function for the portfolio to trigger generating an updated optimized portfolio.

5. The computing device of claim 4, further comprising receiving an input to override the liquidity score for the particular constituent thereby retraining the machine learning model for subsequent predictions for other constituents with the similar characteristics.

6. The computing device of claim 1, wherein the machine learning model uses random forest modelling to predict the liquidity score based on the similar characteristics overlapping between the particular constituent and the other constituents.

7. The computing device of claim 6, wherein the index is a passive fixed income index and the characteristics are selected from the group consisting of: sector, coupon, time to maturity.

8. The computing device of claim 1, wherein the optimized portfolio selects a limited subset of the list of projected constituents from the target index having optimal liquidity scores and associated weighting similar to the weighting in the target index.

9. The computing device of claim 2, wherein the UI provides an interface for receiving further input to modify the optimized set of constituents as recommendations provided by the optimized portfolio, and in response to the input to modify the recommendations, update subsequent recommendations generated based on corresponding characteristics for the optimized set of constituents.

10. The computing device of claim 2, wherein the UI is further configured to receive override requests to the projection of the index from a present state to the future state as the target index thereby modifying the future state including adjustments to the projected constituents; and in response to the override request, updating subsequent projections and generating an electronic report to at least one user associated with receiving the optimized portfolio.

11. A computer-implemented method for automatic generation of a portfolio, the method performed on a computer device, the method comprising:
receiving an index comprising index holdings and characteristics;
automatically projecting the index from a current time period to a future time period as a target index providing a proforma benchmark characterizing a future state of the index holdings, the target index projected based on expected future events impacting the index, the target index comprising: a list of projected constituents, characteristics defining each of the constituents and a weighting of each of the constituents within the target index;
automatically predicting, using a machine learning model, a liquidity score associated with each of the constituents, the liquidity score for a particular constituent based on prior liquidity scores for other constituents in a past time period with one or more similar characteristics to the characteristics of the particular constituent; and
in response to the target index and the liquidity score considered along with a set of pre-defined constraints for desired portfolio characteristics, generating, in real-time on a user interface (UI) of the device, an optimized portfolio providing an optimized set of constituents with associated weighting tracking the target index.

12. The method of claim 11 further comprising: presenting a user interface (UI) to receive a set of pre-defined constraints for desired portfolio characteristics; and updating the optimized portfolio further in response to the pre-defined constraints.

13. The method of claim 12, wherein the optimized portfolio minimizes tracking error to the target index by having a constraint function related to the characteristics for each of the constituents and a penalty function related to the liquidity score of each of the constituents.

14. The method of claim 13, wherein the UI allows modifying a portfolio profile of the optimized portfolio comprising at least one modifying of the constraint function via modification of the desired portfolio characteristics and the penalty function for the portfolio to trigger generating an updated optimized portfolio.

15. The method of claim 14, receiving an input to override the liquidity score for the particular constituent thereby retraining the machine learning model for subsequent predictions for other constituents with the similar characteristics.

16. The method of claim 11, wherein the machine learning model uses random forest modelling to predict the liquidity score based on the similar characteristics overlapping between the particular constituent and the other constituents.

17. The method of claim 16, wherein the index is a fixed income index and the characteristics are selected from the group consisting of: sector, coupon, time to maturity.

18. The method of claim 16, wherein the optimized portfolio selects a limited subset of the list of projected constituents from the target index having optimal liquidity scores and the associated weighting similar to the weighting in the target index.

19. The method of claim 12, wherein the UI provides an interface to receiving input to modify the optimized set of constituents as recommendations provided by the optimized portfolio, and in response to the input to modify the recommendations, update subsequent recommendations generated based on corresponding characteristics for the optimized set of constituents.

20. The method of claim 12, wherein the method further comprises the UI configured to receive override requests to the projection of the index from a present state to the future state as the target index thereby modifying the future state including adjustments to the projected constituents; and in response to the override request, updating subsequent projections and generating an electronic report to at least one user associated with receiving the optimized portfolio.

21. A computer program product comprising a non-transient storage device storing instructions that when executed by at least one processor of a computing device, configure the computing device to:
receive an index comprising index holdings and characteristics;
automatically project the index from a current time period to a future time period as a target index providing a proforma benchmark characterizing a future state of the index holdings, the target index projected based on expected future events impacting the index, the target index comprising: a list of projected constituents, characteristics defining each of the constituents and a weighting of each of the constituents within the target index;
automatically predict, using a machine learning model, a liquidity score associated with each of the constituents, the liquidity score for a particular constituent based on prior liquidity scores for other constituents in a past time period with one or more similar characteristics to the characteristics of the particular constituent; and
in response to the target index and the liquidity score considered along with a set of pre-defined constraints for desired portfolio characteristics, generate, in real-time on a user interface (UI) of the device, an optimized portfolio providing an optimized set of constituents with associated weighting tracking the target index.
